(19) United States
(12) Patent Application Publication
(10) Pub. No.: US 2002/0107788 A1
(43) Pub. Date: Aug. 8, 2002

(54) Application and payment database system for lenders and builders and a method therefor

(76) Inventor: Patrick Steven Cunningham, Scottsdale, AZ (US)

Correspondence Address: WEISS & MOY PC, 4204 NORTH BROWN AVENUE, SCOTTSDALE, AZ, 85251, US

(21) Appl. No.: 09/777,353

(22) Filed: Feb. 5, 2001

(51) Int. Cl. G06F 17/60

(52) U.S. Cl. 705/38; 705/39

(57) ABSTRACT

A loan application and payment system for lenders and builders uses the steps of: establishing an electronic database on a host server by a lender; obtaining credit approval by a builder from the lender; sending an account number and a password by the lender to the builder when the builder has been approved for credit; accessing a construction project account in the electronic database by entering the account number and the password; entering and submitting electronically information related to the construction project; determination of approval of construction loan by the lender based on the information related to the construction project; applying for an application for payment if the construction loan is approved; and transferring monetary funds to the builder after application for payment is submitted and approved.

### BACKGROUND OF THE INVENTION

1. Field of the Invention

This invention relates to financial loans and, more specifically, to a system and method which allows a lender and a builder to communicate information and data via a computer system with minimal errors for the purpose of loan draws for construction projects.

2. Description of the Prior Art

For any construction project, some type of financial backing is required. Generally, financing for construction projects are provided by a bank or other financial institution. The process for obtaining a construction loan differs from one financial institution to another.

In generally, the loan process requires the construction company to supply information related to the construction project. This information is supplied by filing a copious amount of paperwork detailing the specifics of the construction project with the financial information. Many times, redundant paperwork needs to be filed and re-filed. For example, if construction project information that was supplied is incorrect or needs to be updated, additional paperwork needs to be filed and re-filed to properly state the information. This filing and refiling of paperwork is very cumbersome and time consuming.

Therefore, a need existed to provide an improved system and method for the application and payment of construction loans between a lender and the builder. The improved system and method will allow the lender and builder to communicate data over a computerized network system for the purpose of loan draws on construction projects. The improved system and method will provided a standardized database which all lenders may use for loan draws on construction projects. The improved system and method must organize the data in a standardized database form to allow a more accurate and time saving process between the lender and the builder. The improved system and method must further reduce and/or eliminate redundant paperwork associated with present methods.

### SUMMARY OF THE INVENTION

In accordance with one embodiment of the present invention, it is an object of the present invention to provide an improved system and method for the application and payment of construction loans between a lender and the builder.

It is another object of the present invention to provide an improved system and method for the application and payment of construction loans between a lender and the builder that will allow the lender and builder to communicate data over a computerized network system for the purpose of loan draws on construction projects.

It is still another object of the present invention to provide an improved system and method for the application and payment of construction loans between a lender and-the builder that will provided a standardized database which all lenders may use for loan draws on construction projects.

It is still another object of the present invention to provide an improved system and method for the application and payment of construction loans between a lender and the builder that will organize the data in a standardized database form to allow a more accurate and time saving process between the lender and the builder

It is still another object of the present invention to provide an improved system and method for the application and payment of construction loans between a lender and the builder that will reduce and/or eliminate redundant paperwork associated with present methods.

### BRIEF DESCRIPTION OF THE PREFERRED EMBODIMENTS

In accordance with one embodiment of the present invention a loan application and payment system for lenders and builders is disclosed. The method comprises the steps of: establishing an electronic database on a host server by a lender; obtaining credit approval by a builder from the lender; sending an account number and a password by the lender to the builder when the builder has ben approved for credit; accessing a construction project account in the electronic database by entering the account number and the password; entering and submitting electronically information related to the construction project; determination of approval of construction loan by the lender based on the information related to the construction project; applying for an application for payment if the construction loan is approved; and transferring monetary funds to the builder after application for payment is submitted and approved.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

FIG. 1 shows an example of the home web page for the database system of the present invention.

FIG. 2 shows an example of a password request web page for use in the database system of the present invention.

FIG. 3 shows an example of a lender's credit application web page for use in the database system of the present invention.

FIG. 4 shows an example of a lender's web page for use in the database system of the present invention.

FIG. 5 shows an example of an application for payment web page for use in the database system of the present invention.

FIG. 6 shows an example of an application for payment form web page for use in the database system of the present invention.

FIG. 7 shows information related to the builder that may need to be entered into the electronic loan application of the present invention.

FIG. 8 shows information related to each subcontractor/supplier that may need to be entered into the electronic loan application of the present invention.

FIG. 9 shows information related to the owner of the construction project that may need to be entered into the electronic loan application of the present invention.

FIG. 10 shows information related to the construction project that may need to be entered into the electronic loan application of the present invention.

FIG. 11 shows information related to the payment instructions that may need to be entered into the electronic loan application of the present invention.

FIG. 12 shows a flowchart depicting the method of the present invention.

### DETAILED DESCRIPTION OF THE PREFERRED EMBODIMENT

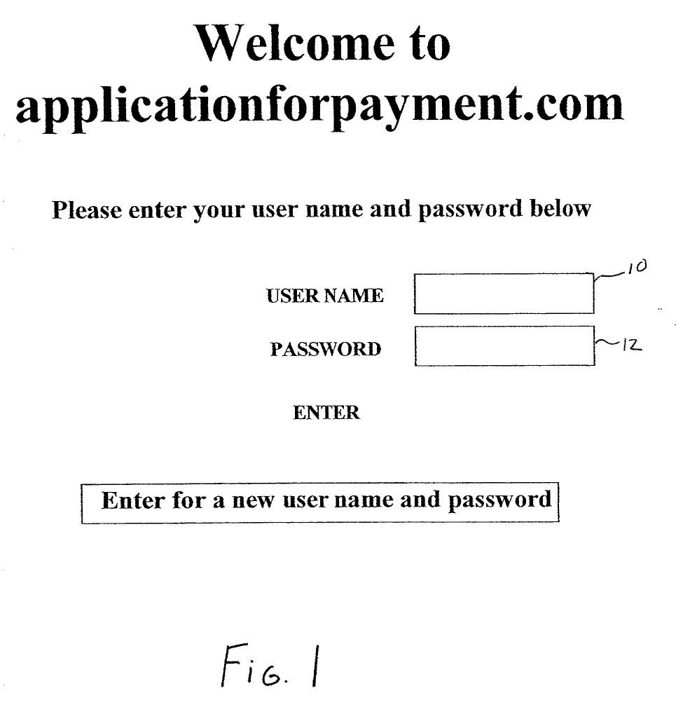

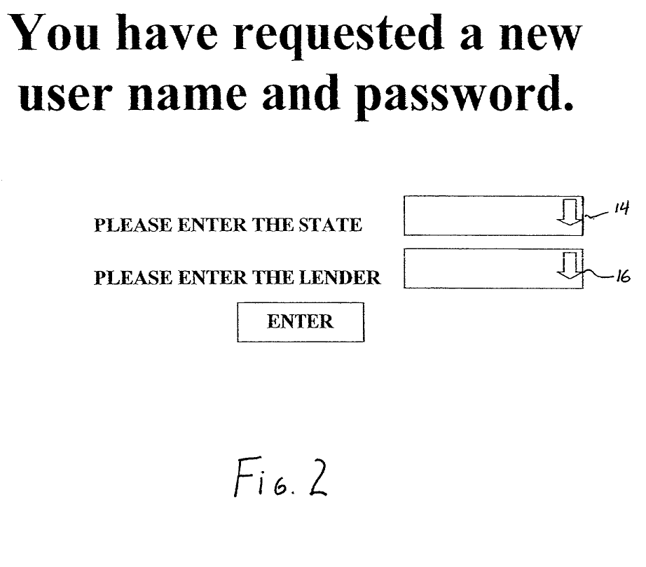

Referring to the Figures, a system and method which will allow for the application and payment of construction loans between a lender and the builder will be described. The system may take advantage of existing networked computerized systems like those presently related to the World Wide Web. An application for loan website is established on a host server. The website will include links to other pages associated with the website which will be described below. The home page of the website is similar to that shown in FIG. 1. The home page will have entries where a builder would enter a user name 10 and a password 12 for entry into the database system. If the builder has no user name and password, the builder would click on a link 14 which will transfer the builder to a password request page which would contain information similar to that shown in FIG. 2. The password request page would allow the builder to select a particular state 14 and a particular financial institution (hereinafter lender) 16 that the builder would like to deal with.

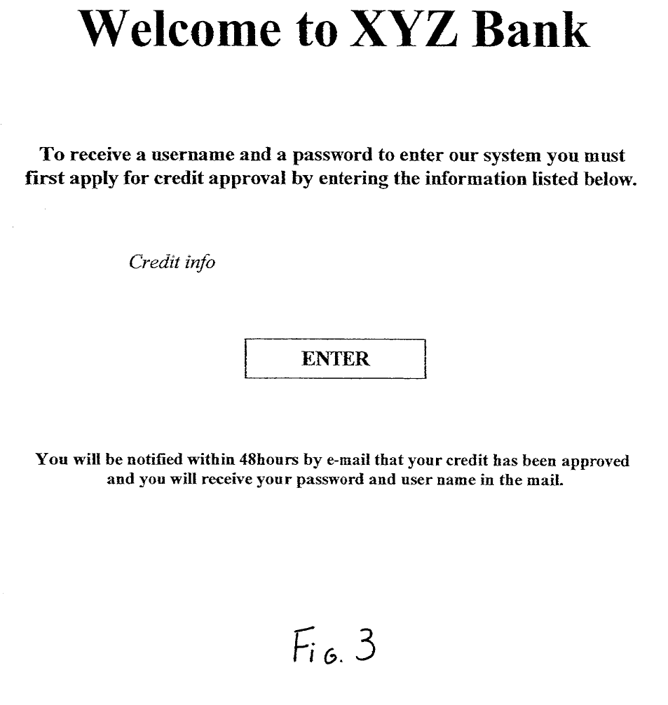

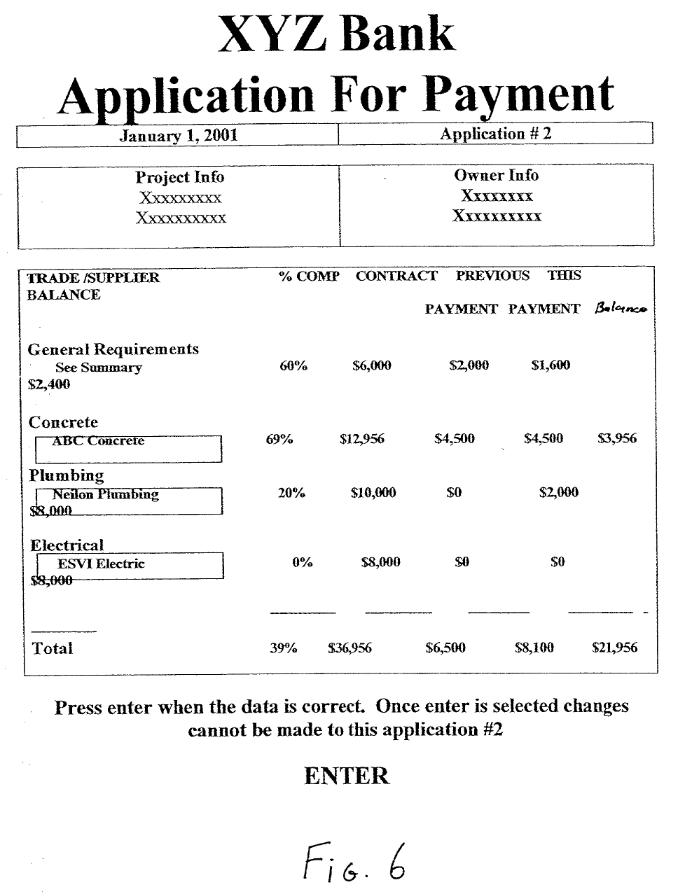

Once the builder has selected a particular state and a particular lender to deal with, the builder will enter the information and will be transfer to a lender's credit application web page. The lender's credit application web page may be similar to that shown in FIG. 3 and will contain a lender's credit application form. The builder must completely fill out the lender's electronic application form. The information on the lender's electronic application form would include the builder's name, address, telephone number, contractor license number, the state where the contractor is registered, the expiration date of the license, the builder's bank and account/checking number, and other similar information. The builder would further include insurance information. For example, the insurance information would include the insurance company, policy number and expiration date for a general liability policy, workman's compensation policy, automobile policy, and others of a like nature. The information is similar to that shown in FIG. 7. The completed form is then submitted electronically to the database system.

If the selected lender accepts the application, the lender would then notify the builder of the account number and password. The lender may notify the builder by any secure means. For example, the lender may send an encrypted electronic message (email) to the builder, send the account number and password by certified or regular mail, or any similar means.

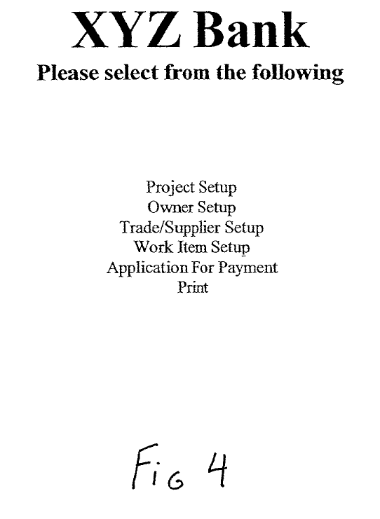

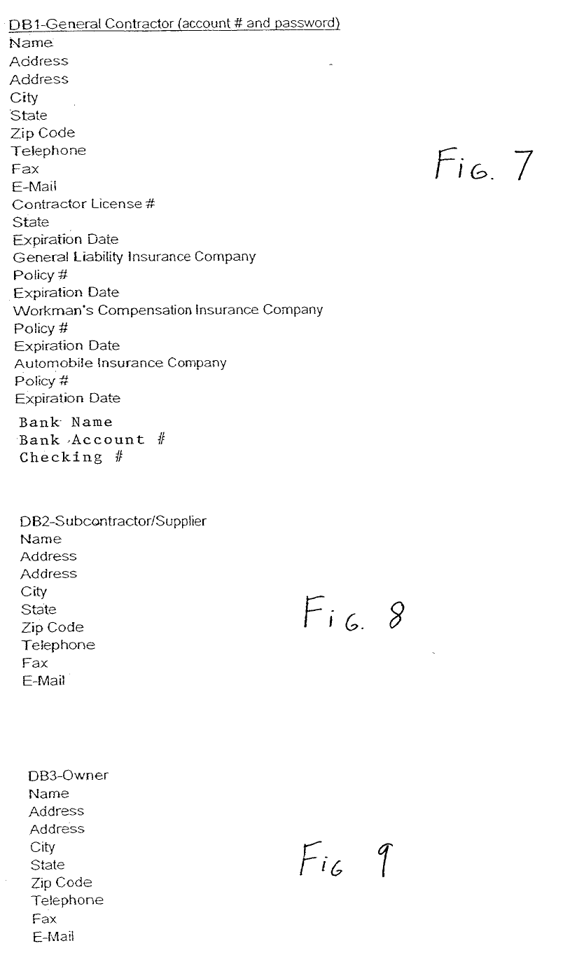

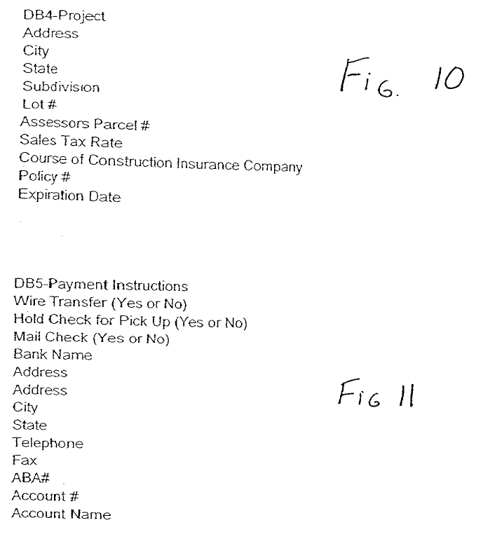

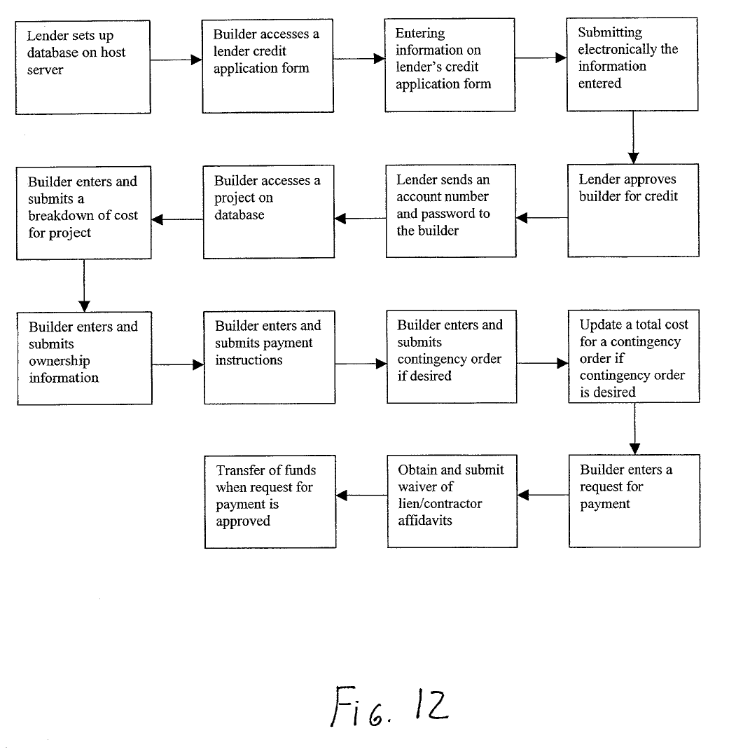

When the builder receives the account number and password, the builder may then access the database system. The lender would go to the home web page as shown on FIG. 1. The builder would then log onto the database using the account information 10 and password 12 supplied by the lender. Once the builder enters the information, the builder will be sent to a financial institution web page of the lender the builder is dealing with. The financial institution web page may take the form as shown in FIG. 4. The lender will ask the builder if the builder wants to access an existing project or to submit for approval a new construction project. If the builder is requesting an approval for a new construction project, the builder will have to submit additional information related to the new construction project. The builder will enter information related to the “breakdown of costs” and project information. This information will include the location of the project (i.e., address, subdivision, lot number), the accessor's parcel number, sales tax rate, and course of construction insurance company, policy number and expiration date. This information is summarized in FIG. 10. The builder will further submit information related to the owner of the construction project. This information will generally include the name, address, telephone number, and similar information related to the owner. This information is summarized in FIG. 9.

The builder will also enter payment instruction. In other words, the builder must inform the lender how the builder wishes to receive any money from the lender if the construction loan is approved. The builder may receive payment in several different manners. For example, the lender may wire transfer the appropriate funds, mail a check, or write a check and hold the check for pick up by someone authorized by the builder. The builder will generally fill in information similar to that shown in FIG. 5 for payment. The lender's web page will have questions such as: wire transfer (yes/no), hold check for pick up (yes/no), and mail check (yes/no) If a wire transfer is requested, the builder will have to supply information for the wire transfer such as the bank's name, address, account name, account number, and like information.

When all the above information is entered, the builder will electronically submit this information to the lender for approval. It should be noted that not all the information shown in FIG. 9, FIG. 10, and FIG. 11 is available to the builder at the start of a project. The remaining information will be requested and must be entered when the builder submits the first draw request/application for payment.

To enter the “breakdown of costs”, the builder would select from a list of work items/trades on the electronic application form and select each that would apply to the project. Once a work item/trade is selected, the builder must indicate if the work item/trade is a “budget, “subcontractor”, a “supplier”, or a “contract labor”. The builder will select “budget” if the builder does not have a firm bid for the work item/trade. If “budget” is selected, the builder will still enter an estimated dollar amount. If the builder does have a firm bid, the builder will make the appropriate selection from “subcontractor”, a “supplier”, or a “contract labor” and then enter the appropriate dollar amount.

The electronic application form will further ask if a “contingency/change order” is required for the project. If the builder answers in the affirmative, the electronic application will automatically create a line item on the application causing a formula to calculate the total cost the lender designates. For example, the lender may designate that this number would be a certain percentage of costs (i.e., 5% of costs).

The lender would then review the information and approve or disapprove the loan. Approval could be done through the computer network system. This would allow automatic “access” to be available by the builder for the project. A written notice of approval could be sent to the builder by fax, mail, electronic mail, or other similar means.

Once approved, the builder would need to access the account and create an individual listing of subcontractors, suppliers, and contract laborers. This information will be added to the electronic application. The information inputted will be the name, address and other similar contact information. The information inputted will be similar to that shown in FIG. 8. More than one subcontractor, supplier, and contract laborer could be entered for one work item/trade. The builder may even enter his company as a subcontractor, supplier, or contract laborer for a particular work item/trade.

After identifying the subcontractor, supplier, or contract laborer that will be assigned to the construction project, the builder will input the contract cost amount for each subcontractor, supplier, and contract laborer in each work item/trade. This amount should not exceed the initial budget approved by the lender on that particular work item/trade.

Once this information is inputted, the electronic application would calculate the difference between the budget amount and the actual cost. If there is an excess, the electronic application will then ask the builder if the excess should be applied to the “contingency/change order” line item on the electronic application. If there is a deficient, this amount is be automatically deducted from the “contingency/change order” budget amount. If the “contingency/change order” line item becomes depleted of it budget amount through change orders or work items/trade deficiencies, then the amount to be distributed to the builder on the requested application for payment is reduced by the difference between the original approved budget amount and the change orders or work items/trade deficiencies.

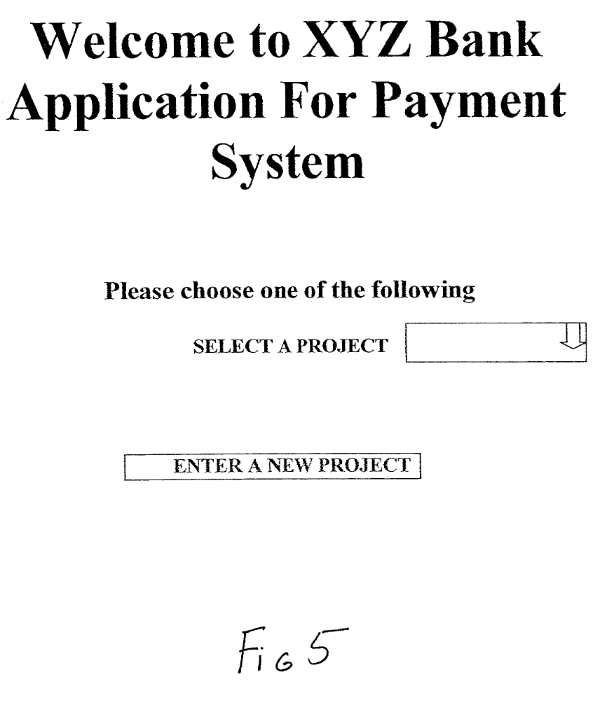

To apply for the draw/payment, would access the application for payment web page by clicking on the link shown in FIG. 4. The builder would then be sent to the appropriate web page similar to that shown in FIG. 5. The builder would select whether payment is for an existing project or for a new project. The builder would then be sent to an application for payment form. The application for payment form is similar to that shown in FIG. 6. The builder would input the draw amount for each work item/trade and follow the guidelines established by the lender. A worksheet may be printed to aid the builder with the input information. The electronic application form will make sure that any information that was not entered (i.e., all the information required like that shown in FIG. 9, FIG. 10, and FIG. 11) is entered before accepting the initial draw request.

After entering all the information necessary for the draw request, the builder will submit this information to the lender. This information may be submit electronically or by any other means the lender may require. When the builder submits the draw request to the lender, an affidavit may appear that states that all information supplied by the builder is accurate. If the information is accurate the builder should agree and submit the affidavit.

It should be noted that at any time during th application process, the builder may print out copies of the electronic application and/or the draw request. The “hard copies” may be kept by the builder for a file history. A history of the electronic application may also be stored in the host server.

Once the draw request is submitted to the lender, the lender will process the request. Process of the request may include an inspection of the project. If the request is approved, the lender will then fund the draw though check, wire transfer or other appropriate means. If the draw is not approved, the lender will notify the builder. The lender would then inform the builder that the builder should resubmit the request.

The above system and method would allow the lender to access and/or receive a multiple of different reports. For example, the lender could access or receive reports of each project history, a report for a summary of project history, a report summary by day of all projects, a report summary by week of all projects, a report summary by month of all projects, and any other similar report. Customization of reports to fit the lenders requirements may be done as required by the lender.

Once a certain part of the construction project is completed, the builder would get at least two copies of each waiver of lien/contractor affidavit form from each contractor, supplier, or contract laborer in the work item/trade that a draw is being requested for. The builder would then forward the properly signed waiver of lien/contractor affidavit form to the lender (i.e., fax, mail, etc.) for the previous draw request prior to receiving funding for the current draw request. The builder would also forward a waiver of lien/contractor affidavit checklist that to the lender with the waiver of lien/contractor affidavits.

The draw request form may take on any type of form. However, the electronic application form should include the following information. First, each work item/trade with the subcontractor, supplier, or contract laborer listed. Second, an area for the “percentage of completion” for each subcontractor, supplier, or contract laborer. Third “contract amount” for each subcontractor, supplier, or contract laborer. Fourth, the “previous payment” for each subcontractor, supplier, or contract laborer. Fifth, “current payment” for each subcontractor, supplier, or contract laborer. Sixth, the “balance of contract” for each subcontractor, supplier, or contract laborer.

If a change occurs during the project, then the “contingency” work item/trade is where the builder would input the information. The builder would input the subcontractor, supplier, or contract laborer for the change order. The builder would then input a brief description of the change order and input the amount of the change. The change order cannot exceed the approved budget amount by the lender. A detail of the “contingency” change order may be printed on a separate sheet with the total of costs transferred to the draw request and/or electronic application.

The electronic application and draw request may further have a general requirements section. General requirements include cost associated with permits, utilities, clean up, and architectural and engineering cost. The general requirements would have a similar work item/trade list. A detailed page may be printed to show the general requirement work items/trade and the subcontractor, supplier or contract laborer for each work item/trade. The total cost for each work item/trade as well as the corresponding subcontractor, supplier or contract laborer will then be transferred to the electronic application and/or the draw request form.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A loan application and payment system for lenders and builders comprising the steps of:
establishing an electronic database on a host server by a lender;
obtaining credit approval by a builder from the lender;
sending an account number and a password by the lender to the builder when the builder has ben approved for credit;
accessing a construction project account in the electronic database by entering the account number and the password;
entering and submitting electronically information related to the construction project;
determination of approval of construction loan by the lender based on the information related to the construction project;
applying for an application for payment if the construction loan is approved; and
transferring monetary funds to the builder after application for payment is submitted and approved.

2. The method of claim 1 wherein the step of accessing a construction project account further comprises the steps of:
accessing a lender application form on the electronic database by the builder;
entering builder information in the lender application by builder;
submitting electronically the builder information to the electronic database; and
sending the account number and password to the builder.

3. The method of claim 2 wherein the step of entering and submitting electronically information related to the construction project further comprises:
entering and electronically submitting a breakdown of cost for the construction project;
entering and submitting ownership information related to the construction project; and
entering and electronically submitting payment instructions.

4. The method of claim 3 wherein the step of entering and electronically submitting a breakdown of cost for the construction project further comprises:
entering and electronically submitting different work items on the construction project;
entering one of budget, subcontractor, supplier, or contract labor for each work item submitted;
entering monetary amounts for each work item submitted; and
submitting electronically data related to each work item.

5. The method of claim 4 further comprising the steps of:
entering and submitting a contingency/change order should the builder want one for the construction project; and
calculating a total cost for the contingency/change order based on guidelines established by the lender.

6. The method of claim 5 wherein the step of applying for an application for payment if the construction loan is approved further comprises the steps of:
entering and electronically submitting a draw amount for each work item; and
submitting electronically an affidavit that all data submitted related to the application for payment is accurate.

7. The method of claim 6 further comprising the steps of:
obtaining properly signed waiver of lien/contractor affidavits from each subcontractor, supplier, or contract labor in the work item that the application for payment is being requested for; and
sending the properly signed waiver of lien/contractor affidavits from each subcontractor, supplier, or contract labor in the work item that the application for payment is being requested for to the lender.
